(19) United States
(12) Patent Application Publication
(10) Pub. No.: US 2024/0144345 A1
(43) Pub. Date: May 2, 2024

(54) EXCHANGING VIRTUAL MACHINE INSTANCES BASED ON REFUND AND PURCHASE RECOMMENDATIONS

(71) Applicant: SAP SE, Walldorf (DE)

(72) Inventors: Bernard Wang, Campbell, CA (US); Donghua Chen, Palo Alto, CA (US); Kevin Wu, San Francisco, CA (US); Xiaorui Le, Bellevue, WA (US); Rizwanulla Mohammed, Seattle, WA (US); Wallace Suleiman, Cupertino, CA (US); Thomas Lee, San Francisco, CA (US)

(21) Appl. No.: 17/978,306

(22) Filed: Nov. 1, 2022

(51) Int. Cl. G06Q 30/06; G06F 9/50

(52) U.S. Cl. CPC G06Q 30/0631; G06F 9/5077; G06F 2209/501; G06F 2209/5019; G06F 2209/508

(57) ABSTRACT

Utilization data of reserved virtual machine (VM) instances can be obtained from a cloud service provider. A refund recommendation comprising a first quantity of VM instances and a refund credit associated with the first quantity of VM instances can be generated based on the utilization data. A purchase recommendation comprising a second quantity of VM instances and a purchase cost associated with the second quantity of VM instances can be generated. An exchange transaction to return the first quantity of VM instances and purchase the second quantity of VM instances can be generated, where a net total of the exchange transaction is determined based on the refund credit and the purchase cost.

### BACKGROUND

One important cloud computing resource is virtual machines (VMs) that are computer systems in the cloud. There are two main ways to purchase VMs from the major cloud service providers: on-demand and upfront. On-demand means that the VMs are purchased through a pay-as-you-go model, where the cost of VMs are calculated by the amount of time they are actually used. In contrast, upfront means reserving the VMs for a contracted period of time and paying for the cost upfront, where the cost of VMs are calculated by the contracted period of time regardless of whether the VMs are actually used or not. Typically, paying for VMs upfront is more cost efficient than paying for VMs on demand.

### SUMMARY

The present disclosure describes an approach to exchange virtual machine instances based on refund and purchase recommendations.

In an implementation, utilization data of reserved virtual machine (VM) instances is obtained from a cloud service provider. A refund recommendation comprising a first quantity of VM instances and a refund credit associated with the first quantity of VM instances is generated based on the utilization data. A purchase recommendation comprising a second quantity of VM instances and a purchase cost associated with the second quantity of VM instances is generated. An exchange transaction to return the first quantity of VM instances and purchase the second quantity of VM instances is executed, where a net total of the exchange transaction is determined based on the refund credit and the purchase cost.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages.

First, the techniques described herein can automatically calculate a refund recommendation and/or a purchase recommendation. Instead of manually determining which reserved instances should be refunded and/or purchased, the techniques can automatically collect data of the reserved VM instances, evaluate and analyze the data, and automatically generate a refund recommendation and/or a purchase recommendation, which may be immediately actionable via a user interface. This can enhance the efficiencies of VM exchange transactions. Furthermore, the recommendations can be based on internal goals of an entity, which ensures that all organizations of the entity are collectively moving towards the common goals.

Second, the techniques described herein provide an explicit way to limit spending amounts (e.g., based on daily purchase power and/or weekly purchase power). This streamlines the exchange process by reducing the discussions and approvals for budget for every exchange executed. Furthermore, by limit spending amounts, the chance of accidental over-purchasing is also decreased.

Third, all monetary amounts displayed are scaled by any negotiated discounts provided by cloud service providers. This enhances the efficiencies of cost calculations and reduces the likelihood of calculation errors introduced by manual application of negotiated discounts.

Fourth, the techniques described herein enable all organizations of an entity to have access to all functionality needed to monitor and update their cloud workload within a single, centralized platform. As the entity transitions to multi-cloud strategy, some organizations of the entity will have different cloud services hosted by different cloud service providers. Housing all necessary cloud cost analysis and optimization functionality in a centralized platform can enhance scalability of cloud migration.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example system for exchanging VM instances based on refund and purchase recommendations, according to an implementation of the present disclosure.

FIG. 2 is a flowchart illustrating an example of a computer-implemented method for exchanging VM instances based on refund and purchase recommendations, according to an implementation of the present disclosure.

FIG. 3 illustrates an example refund recommendation page, according to an implementation of the present disclosure.

FIG. 4 illustrates an example refund adjustment page, according to an implementation of the present disclosure.

FIG. 5 illustrates an example purchase recommendation page, according to an implementation of the present disclosure.

FIG. 6 illustrates an example review page, according to an implementation of the present disclosure.

FIG. 7 is a block diagram illustrating an example of a computer-implemented System used to provide computational functionalities associated with described algorithms, methods, functions, processes, flows, and procedures, according to an implementation of the present disclosure

Like reference numbers and designations in the various drawings indicate like elements.

### DETAILED DESCRIPTION

The following detailed description describes an approach to exchange virtual machine (VM) instances based on refund and purchase recommendations, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Typically, paying for VMs upfront is more cost efficient than paying for VMs on demand. Hereinafter, we refer to the VMs that are paid upfront as reserved instances. While reserved instances are an effective way of saving money in the long run, an entity who pays for and uses the reserved instances typically has a fluctuating workload. This can result in a shortage of VMs in some area (e.g., region, service type, etc.) when the current workload and/or expected workload in that area exceeds the capacity of the reserved instances. In addition, this can result in an excess of VMs in some areas when the capacity of the reserved instances in a particular area exceeds the current workload and/or expected workload. To address this problem, a cloud service provider can provide the ability to exchange reserved instances for those that better fit the entity's workload. For example, an entity may have paid for, but may not have used, some reserved instances in the west region of a cloud, but may have a shortage of VMs in the east region of the cloud. The entity can return the reserved instances in the west region for a refund and use the refund to purchase additional reserved instances in the east region. For another example, an entity may have paid for some reserved instances that are not used at present. However, these reserved instances are expected to be used at a future time because the workload of the entity is expected to grow at the future time. The entity can return the reserved instances for a refund and use the refund to sign a new contract to begin using these reserved instances at a future date.

However, these exchange functionalities have significant limitations. First, manual processes are needed to determine the reserved instances to return and/or the reserved instances to purchase. The manual processes are time-consuming and error-prone. Second, purchase amounts are not limited by user accounts, meaning that it is difficult to track available budget and the likelihood that purchase amounts inadvertently exceed approved budgets is increased. Third, pricing of reserved instances is not scaled by negotiated discounts, resulting in potential miscalculations of refund credit and purchase cost.

The techniques described herein can solve the problems described above. In some cases, data of the reserved instances, such as utilization data, can be automatically collected and analyzed. The refund recommendations and/or the purchase recommendations can be automatically generated based on the analysis of the reserved instances. In some implementations, a purchase limit, such as daily purchase power and/or weekly purchase power, can be set for a user account. The purchase limit can be an amount the user account is allowed to spend over a predetermined period of time. In some examples, all negotiated discounts can be applied to the cost or pricing that is used to calculate refund credit and/or purchase cost.

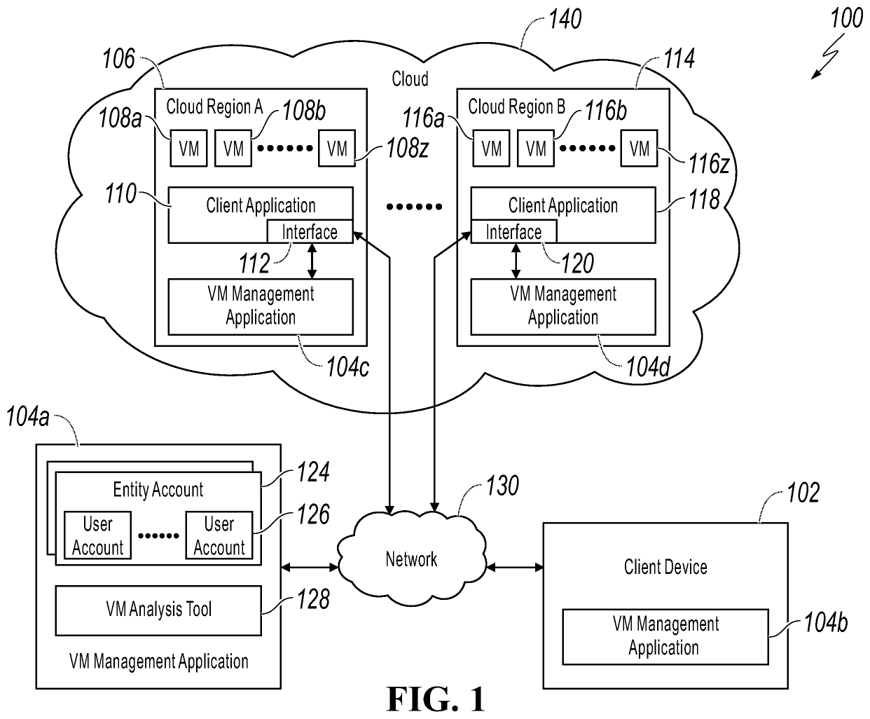

FIG. 1 is a block diagram illustrating an example system 100 for exchanging VM instances based on refund and purchase recommendations. In general, the system 100 allows the illustrated components to share and communicate information across devices and systems (e.g., client device 102, VM management application 104a, and cloud 140, among others, via network 130). As described herein, the client device 102 and/or the VM management application 104a may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server.

As used in the present disclosure, the term “computer” is intended to encompass any suitable processing device. For example, the client device 102 and/or the VM management application 104a may be any computer or processing devices such as, for example, a blade server, general-purpose personal computer (PC), Mac®, workstation, UNIX-based workstation, or any other suitable device. Moreover, although FIG. 1 illustrates a single client device 102, a single VM management application 104a, and a single cloud 140, any one of the client device 102, the VM management application 104a, and/or the cloud 140 can be implemented using a single system or more than those illustrated, as well as computers other than servers, including a server pool. In other words, the present disclosure contemplates computers other than general-purpose computers, as well as computers without conventional operating systems. In some instances, the client device 102 and/or the VM management application 104a may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™ Android™, Windows Phone OS, or iOS™, among others. The client device 102 and/or the VM management application 104a may include one or more VM-specific applications executing on the client device 102 and/or the VM management application 104a, or the client device 102 and/or the VM management application 104a may include one or more Web browsers or web applications that can interact with particular applications executing remotely from the client device 102 and/or the VM management application 104a, such as the client application 110, among others.

The VM management application 104a may be associated with a tenant of the cloud 140 and/or an operator of the cloud 140. The tenant and/or the operator can interact with the cloud 140 via the VM management application 104a to perform one or more VM exchange transactions. The VM management application 104a can, for instance, make VM refund and purchase recommendations to a user of an entity, and implement VM exchange transactions. While the VM management application 104a is illustrated as separated from the client device 102 or the cloud 140, the VM management application can be executed in, for example, at least one of the client device 102, as illustrated by 104b, or the cloud 140 as illustrated by 104c and 104d. Additionally, the VM management application 104 can be used by multiple users and systems, in some cases, allowing a single application 104 with multiple instances for different users and entities to be executed, such as in the cloud 140. Any suitable solution may be implemented within the scope of the present disclosure.

The VM management application 104a may include any suitable application, program, mobile app, or other component. The VM management application 104a can interact with the client device 102, the cloud 140, and/or portions thereof, via network 130. In some instances, the VM management application 104a may be a web browser, where the functionality of the VM management application 104a may be realized using a web application or website the user can interact with via the VM management application 104a. In other instances, the VM management application 104a may be a remote agent, component, or client-side version of the client device 102, or a dedicated application associated with the client device 102. The VM management application 104a may be used to view, interact with, or otherwise transact data exchanges and transactions with the client application 110, and to allow interactions for VM exchange transactions.

In some implementations, the VM management application 104a may be associated with or store one or more entity accounts 124, where each entity account 124 may be associated with or store one or more user accounts 126. The entity account 124 can be associated with, for example, a line of business (LoB) of an organization, a division of an organization, a department of an organization, etc. The entity account 124 can include or store statistics data of VMs reserved by the entity (or particular portions, groups, LoBs, divisions, departments, etc.) associated with the entity account 124. The statistics data of VMs can be, for example, the VM's service types, regions, start dates, end dates, upfront costs, pay as you go (PAYG) costs, VM purchase recommendations, etc. Each entity account 124 can be associated with a purchase power (e.g., daily purchase power, weekly purchase power, etc.) indicating an amount the entity associated with the entity account is allowed to spend over a predetermined period of time (e.g., daily, weekly, etc.). The entity account 124 can further be associated with a cost center and store payment information for the entity to perform quicker and more efficient VM exchange transactions. Each user account 126 can be associated with a user-specific identifier (ID). The user-specific ID can be in any suitable format and may include any characters used to create a unique identifier for a particular user. The user account 126 can be associated with a user of an entity, such as an employee of the entity, a stakeholder of the entity, a representative of the entity, etc. Each user account 126 can be associated with a user-specific identifier (ID). The user-specific ID can be in any suitable format and may include any characters used to create a unique identifier for a particular user. The user account 126 can further include or store a user profile, which can include personally identifiable information (PII) of the corresponding user. That information may include a name, an address, and employment information, among others. Similar to the purchase power of entity account 124, the user account 126 can also be associated with a purchase power (e.g., daily purchase power, weekly purchase power, etc.) indicating an amount the user associated with the user account 126 is allowed to spend over a predetermined period of time (e.g., daily, weekly, etc.), which may be a portion of the purchase power of the entity account 124. The user's purchase power may also be the entirety of the purchase power of the entity account 124, and may be set by administrators or trusted users to determine the appropriate purchase power of each user.

The VM management application 104a can include, among other components, one or more applications, entities, programs, agents, or other software or similar components capable of performing the operations described herein. As illustrated, the VM management application 104a includes or is associated with a VM analysis tool 128. The VM analysis tool 128 may be any application, program, other component, or combination thereof that is used to analyze VM reservations, make VM refund recommendations, and make VM purchase recommendations, among others.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The cloud 140 may be owned or operated by a cloud service provider, such as Amazon Web Services (AWS), Microsoft Azure, and Google Cloud Platform (GCP), among others. The cloud service provider can provide (e.g., lease) cloud computing resources, including VMs, servers, storage, databases, networking, software, analytics, intelligence, etc., to its tenants. The cloud 140 can include a plurality of data centers located in multiple geographical regions, such as the cloud region A 106 and cloud region B 114 as illustrated.

The cloud region A 106 can include a plurality of VMs 108a-108z. The cloud service provider can lease one or more of VMs 108a-108z to one or more tenants. The cloud region A can further include a client application 110. The client application 110 can be, for example, the application of a tenant used to collect statistics of the VMs that the tenant has reserved (e.g., leased), including utilization data of the VMs. The client application 110 can include one or more interfaces 112. The interface 112 of the client application 110 is used for communicating with other systems in a distributed environment—including within the system 100—connected to the network 130, for example, VM management application 104a, client device 102, the client application(s) running in other cloud region(s), and other systems communicably coupled to the illustrated system 100 and/or network 130. Generally, the interface 112 comprises logic encoded in software and/or hardware in a suitable combination and operable to communicate with the network 130 and other components. More specifically, the interface 112 may comprise software supporting one or more communication protocols associated with communications such that the network 130 and/or interface's hardware is operable to communicate physical signals within and outside of the illustrated system 100. Still further, the interface 112 may allow the client application 110 to communicate with the client device 102, the VM management application 104a, and/or other portions illustrated within the cloud 140 to perform the operations described herein. As noted, a VM management application 104c may be installed and run in the cloud region A 106.

The cloud region B 114 can include a plurality of VMs 116a-116z, a client application 118 which includes one or more interfaces 120, and a VM management application 104d. The functions and roles of each module in the cloud region B 114 can be referenced to the descriptions of corresponding modules in the cloud region A 106. Details are omitted here for simplicity.

The client device 102 can be associated with a tenant of the cloud 140 and/or an operator of the cloud 140. The client device 102 may be associated with a particular user, or may be accessed by multiple users, where a particular user is associated with a current session or interaction at the client device 102. Client device 102 may be a client device at which an entity of the entity account 124 is linked or associated, a client device at which the user of the user account 126 is linked or associated, or a client device through which the particular user interacts with VM management application 104a and cloud 140. As noted, a VM management application 104b may be installed and run in the client device 102.

The illustrated client device 102 is intended to encompass any computing device such as a desktop computer, laptop/notebook computer, mobile device, smartphone, personal data assistant (PDA), tablet computing device, one or more processors within these devices, or any other suitable processing device. In general, the client device 102 and its components may be adapted to execute any operating system, including Linux, UNIX, Windows, Mac OS®, Java™ Android™, or iOS. In some instances, the client device 102 may comprise a computer that includes an input device, such as a keypad, touch screen, or other device(s) that can interact with one or more client applications, such as one or more mobile applications, including for example a web browser, a VM management application, or other suitable applications, and an output device that conveys information associated with the operation of the applications and their application windows to the user of the client device 102. Such information may include digital data, visual information, or a GUI. Specifically, the client device 102 may be any computing device operable to communicate with the cloud 140, the VM management application 104a, other client device(s), and/or other components via network 130, as well as with the network 130 itself, using a wireline or wireless connection. In general, client device 102 comprises an electronic computer device operable to receive, transmit, process, and store any appropriate data associated with the system 100 of FIG. 1.

Network 130 facilitates wireless or wireline communications between the components of the system 100 (e.g., between the cloud 140, the client device 102, the VM management application 104a, etc.), as well as with any other local or remote computers, such as additional mobile devices, clients, servers, or other devices communicably coupled to network 130, including those not illustrated in FIG. 1. In the illustrated environment, the network 130 is depicted as a single network, but may be comprised of more than one network without departing from the scope of this disclosure, so long as at least a portion of the network 130 may facilitate communications between senders and recipients. In some instances, one or more of the illustrated components (e.g., the cloud 140, the client device 102, the VM management application 104a, etc.) may be included within or deployed to network 130, or a portion thereof as one or more cloud-based services or operations. The network 130 may be all or a portion of an enterprise or secured network, while in another instance, at least a portion of the network 130 may represent a connection to the Internet. In some instances, a portion of the network 130 may be a virtual private network (VPN). Further, all or a portion of the network 130 can comprise either a wireline or wireless link. Example wireless links may include 802.11a/b/g/n/ac, 802.20, WiMax, LTE, and/or any other appropriate wireless link. In other words, the network 130 encompasses any internal or external network, networks, sub-network, or combination thereof operable to facilitate communications between various computing components inside and outside the illustrated system 100. The network 130 may communicate, for example, Internet Protocol (IP) packets, Frame Relay frames, Asynchronous Transfer Mode (ATM) cells, voice, video, data, and other suitable information between network addresses. The network 130 may also include one or more local area networks (LANs), radio access networks (RANs), metropolitan area networks (MANs), wide area networks (WANs), all or a portion of the Internet, and/or any other communication system or systems at one or more locations.

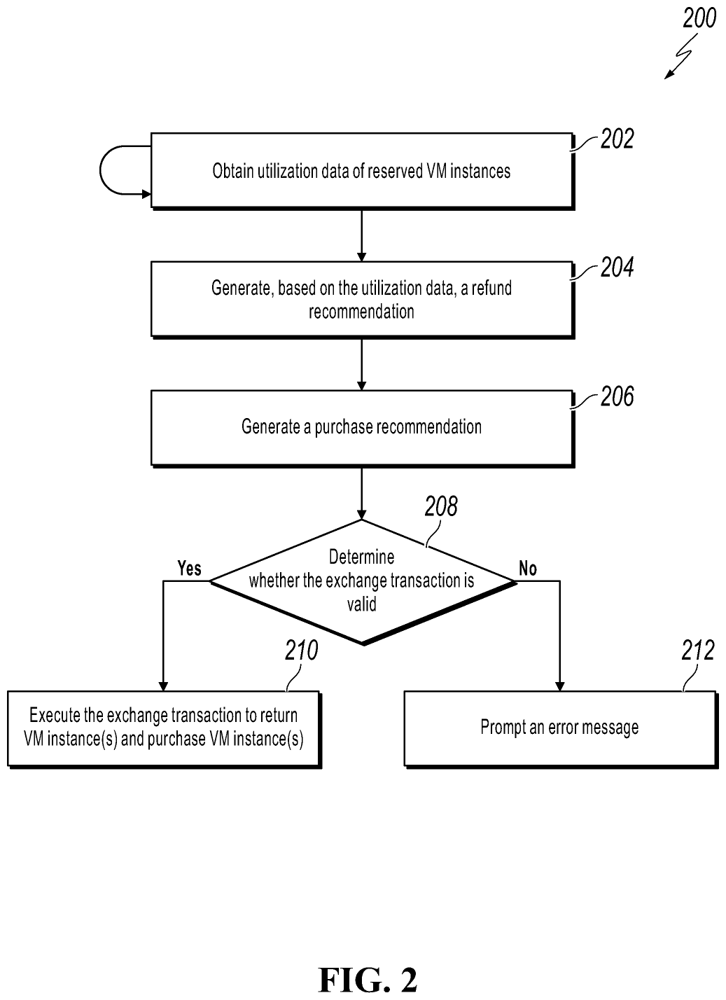

FIG. 2 is a flowchart illustrating an example of a computer-implemented method 200 for exchanging VM instances based on refund and purchase recommendations, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some instances, method 200 can be performed by a VM management application (e.g., the VM management application 104a, 104b, 104c, or 104d), or portions thereof, described in FIG. 1, as well as other components or functionality described in other portions of this description. In other instances, method 200 may be performed by a plurality of connected components or systems, such as those illustrated in FIG. 1. Any suitable system(s), architecture(s), or application(s) can be used to perform the illustrated operations. In some implementations, various steps of method 200 can be run in parallel, in combination, in loops, or in any order.

At 202, utilization data of reserved VM instances can be obtained. In some implementations, in addition to the utilization data, the VM management application can obtain other data of the reserved VM instances, such as VM service types, regions, start dates, end dates, upfront costs, pay as you go (PAYG) costs, and VM purchase recommendations, among others. In some instances, a client application can be installed and run in a cloud (e.g., the cloud 140 described in FIG. 1) where the reserved VM instances are located. The client application can continuously (e.g., periodically) obtain data, including utilization data, of the reserved VM instances. The VM management application can then retrieve the data of the reserved VM instances from the cloud via an interface of the client application (e.g., the interface 112 described in FIG. 1). The interface of the client application can be, for example, an application programming interface (API).

In some cases, the VM management application can retrieve data, including utilization data, of the reserved VM instances periodically, so that the data of the reserved VM instances can be as-up-to date as possible. For example, the VM management application can run scheduled jobs at certain times of the day to retrieve updated data of the reserved VM instances. In some cases, these scheduled jobs can be run at minimum once per 24 hours, which ensures that any recommendations, utilization, pricing, or any other data that fluctuates will never be stale. In some implementations, the VM management application can retrieve data of the reserved VM instances upon request. For example, the VM management application can retrieve the data when a user triggers a data retrieval operation in the VM management application, or when a user accesses the VM management application.

In some instances, one or more entities of a tenant (e.g., one or more LoBs of an enterprise) can access and retrieve the data of the reserved VM instances via a service account associated with a particular cloud. The service account can be created (e.g., registered) and assigned to the VM management application for accessing and retrieving the data of the reserved VM instances included in the particular cloud. The service account can also be used to handle necessary access permissions to obtain data from the particular cloud. In some cases, the VM management application can be assigned a plurality of service accounts, each service account corresponding to a respective cloud service provider. For example, the VM management application can have three separate service accounts to access AWS, Microsoft Azure, and GCP, respectively, each service account being used to access and retrieve data of the reserved VM instances in the corresponding cloud service provider.

In some instances, one or more entity accounts (e.g., the one or more entity accounts 124 as described in FIG. 1) can be created in the VM management application and assigned to an entity for one or more users of the entity to access the VM management application. In some cases, one or more user accounts (e.g., the one or more user accounts 126 as described in FIG. 1) can be created under an entity account and assigned to one or more users who belong to the entity. A user can have access to the VM management application and one or more of its functionalities (e.g., read, write, transact, etc.) via the user account. In some cases, not all users of an entity may have permission to execute VM exchange transactions, and the VM exchange functionality can be reserved for only selected users. Therefore, an exchange permission can be defined in the user account and a user can execute the VM exchange transaction if the user is granted the exchange permission.

In some examples, a user can be assigned a daily purchase power and/or a weekly purchase power, as well as other time-based limits to their purchase power. These amounts can be added to the user account associated with the user to comply with any budgets allocated by the entities (e.g., LoBs). Daily purchase power represents the monetary amount that a user can spend in one day, while weekly purchase power is the total amount a user can spend in a week. Each one of the daily purchase power and weekly purchase power can be reset according to their periods—daily purchase power can be reset every 24 hours and weekly purchase power can be reset every 7 days. Users are restricted from exceeding these limits by, for example, checks in both the client and the server.

In some cases, the VM management application can obtain a preliminary cost for a VM instance reservation from the cloud to determine, for example, refund credit and/or purchase cost. However, the preliminary cost may not consider any negotiated discounts provided by the cloud service provider. In such case, the VM management application can apply the negotiated discounts to the preliminary cost to determine a discounted cost and display the discounted cost in an interface of the VM management application to the user. In some cases, the VM management application can apply the discounts to all pricing involved in the exchange process and display the discounted pricing. Table 1 illustrates an example of how such discounts would be applied to pricing.

TABLE 1

| VMs purchased | On-demand pricing | Reserved instance pricing |
|---|---|---|
| VMs purchased | discounted by A % | discounted by B % |
| after Jan. 1, 2022 | | |
| VMs purchased | discounted by C % | discounted by D % |
| between | | |
| Jan. 1, 2021 and | | |
| Jan. 1, 2022 | | |
| VMs purchased | discounted by E % | discounted by F % |
| before Jan. 1, 2021 | | |

At 204, the VM management application can generate, based on the utilization data, a refund recommendation. In some instances, generating the refund recommendation includes determining, based on the utilization data, a recommended return quantity of VM instances to be returned to the cloud service provider. In some cases, the utilization data can be a ratio between a quantity of reserved VM instances that are being used and a total quantity of the reserved VM instances in a reservation. The utilization data can be, for example, 1-Day utilization data, 7-Day utilization data, 30-Day utilization data, or utilization over any other predetermined period for the reserved VM instances in a reservation. The utilization data can be average utilization over the predetermined period of time, peak utilization over the predetermined period of time, or lowest utilization over the predetermined period of time.

After obtaining the utilization data of the reserved VM instances, the VM management application can use the utilization data to determine whether the reserved VM instances should be recommended for refund. If the VM management application determines that the reserved VM instances should be recommended for refund, the VM management application can further determine a recommended return quantity. To determine whether the reserved instances should be recommended for refund, the VM management application can check the utilization data (e.g., 7-Day utilization data) of the reserved VM instances. If the utilization of the reserved VM instances is greater than a predetermined utilization threshold (e.g., 90%), the reserved VM instances may not be recommended for refund. If the utilization of the reserved VM instances is less than or equal to the predetermined utilization threshold (e.g., 90%), the VM management application can determine that the reserved VM instances should be recommended for refund. To determine a recommended return quantity of VM instances, the VM management application can, for example, use the following formula to calculate the recommended return quantity:

Recommended return quantity=(1−utilization (%))*the total quantity of the reserved VM instances

For example, if the 7-Day utilization is 80% (0.8), and there are 10 total reserved VM instances in this reservation, the recommended return quantity would be two VM instances.

In some cases, alongside the algorithm to determine the recommended return quantity of VM instances to refund, the VM management application can also calculate the amount of credit that would be generated through this refund. Credit can be, for example, a monetary amount generated through the return of reserved instances and can be used in the purchase step of exchange. In some instances, credit can be calculated as follows:

Credit=upfront cost−used cost

In this equation, upfront cost can be the total cost of the reservation that is recommended for refund. For example, if the reservation term is 3 years and the daily cost is $1, then the total upfront cost would be:

upfront cost=3 years*(365 days)/year*$1/day=$1095

Used cost can be the total cost of the reservation up to the refund date. In the same example as above, suppose that the daily cost is $1 and the reserved instance is being refunded after 1 year of usage.

used cost=1 year*(365 days)/year*$1/day=$365

Thus, credit would be calculated as:

Credit=upfront cost−used cost=$1095−$365=$730

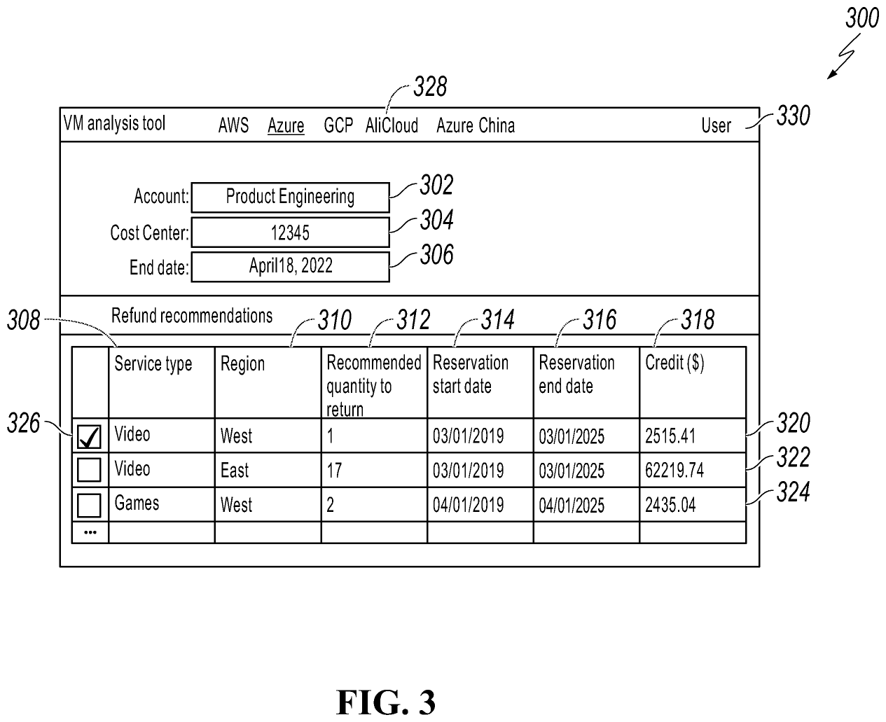

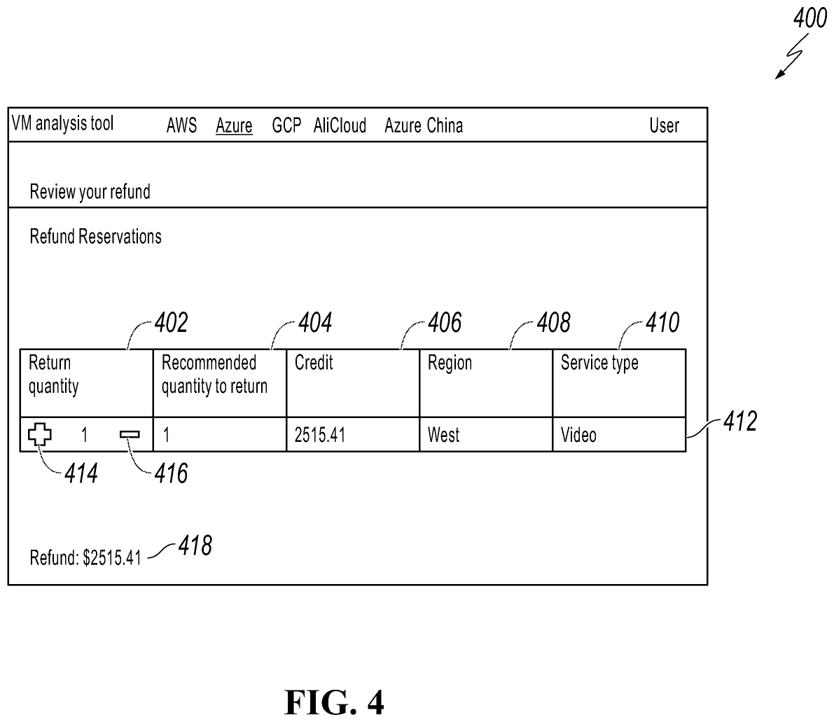

In some implementations, the upfront cost, the used cost, the daily cost, and/or the credit is the discounted cost as described in step 202 above. In some instances, the VM management application can display a page showing the refund recommendation to a user, such as the example refund recommendation page 300 as described in FIG. 3. In some instances, after the user selects the reserved instances to refund, the VM management application can display a refund adjustment page showing the VM instance reservation(s) selected by the user, such as the example refund adjustment page 400 as described in FIG. 4, where the user can make adjustments to the return quantities.

At 206, a purchase recommendation can be generated. In some examples, the cloud service provider can provide a VM purchase recommendation by calculating current and/or expected usage not yet covered by currently reserved VM instances and determining the quantity of VM instances that are still needed for the uncovered usage. In some cases, the VM management application can obtain the VM purchase recommendations from the cloud service provider via an interface (e.g., an API) associated with the cloud service provider based on the process described in step 202 above. In some cases, the VM management application can provide historical usage of on-demand instances (e.g., usage of the on-demand instances in the last seven days, usage of the on-demand instances in the last 30 days, etc.) to the cloud service provider. The cloud service provider can input the historical usage of on-demand instances to an algorithm to generate the purchase recommendations of reserved instances. The cloud service provider can then return the purchase recommendations to the VM management application.

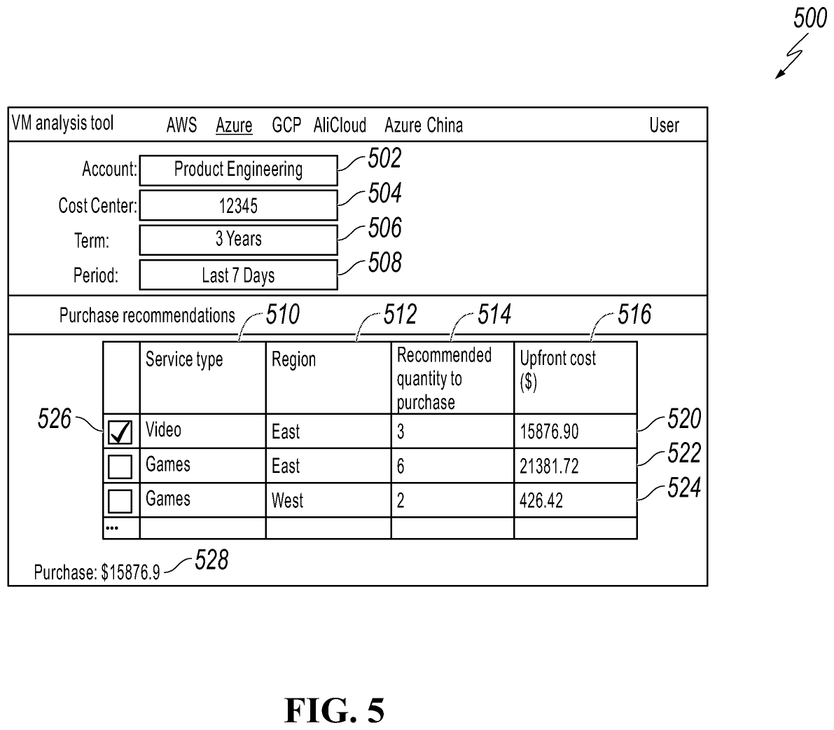

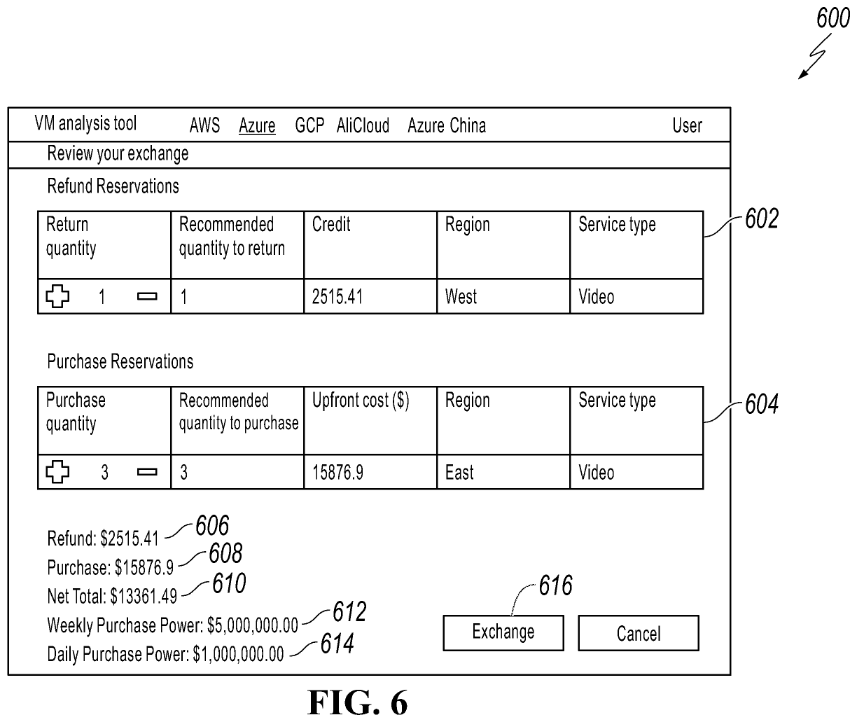

In some instances, the VM management application can display a page showing the purchase recommendation to a user, such as the example purchase recommendation page 500 as described in FIG. 5. In some instances, after the user selects the reserved instances to purchase, the VM management application can display a review page to the user, such as the example review page 600 as described in FIG. 6.

At 208, it can be determined whether the exchange transaction is valid. In some cases, the VM management application can perform one or more of the following checks to determine whether the exchange transaction is valid:
1. determining whether the net total is greater than 0;
2. determining whether the net total is less than or equal to one or more purchase powers;
3. determining whether each of the refund credit and the purchase cost is greater than 0; or
4. determining whether there is at least one reserved instance refunded and at least one reserved instance purchased in the exchange transaction.

In some cases, the exchange transaction is valid if the results of all of the four checks are positive. In some examples, the net total can be determined by subtracting the refund credit from the purchase cost.

In some implementations, determining whether the net total is less than or equal to one or more purchase powers includes determining whether the net total is less than or equal to the daily purchase power and/or the weekly purchase power. In some examples, the weekly purchase power can take precedence over the daily purchase power. Specifically, the net total can first be compared with the weekly purchase power. If the net total is greater than the weekly purchase power, the exchange transaction can be determined to be invalid; otherwise, the net total can then be compared with the daily purchase power. If the net total is less than or equal to the daily purchase power, the exchange transaction can be determined to pass the purchase power check, i.e., the check #2 described above.

At 210, the exchange transaction can be executed to return VM instance(s) and purchase VM instance(s), if the exchange transaction is determined to be valid. In some cases, the VM management application can send an exchange request to an interface associated with the cloud service provider for executing the exchange transaction. In some cases, after executing the exchange transaction, the daily purchase power can be updated by subtracting the net total from the daily purchase power. Likewise, the weekly purchase power can be updated by subtracting the net total from the weekly purchase power.

At 212, an error message can be prompted, if the exchange transaction is determined to be invalid. In some instances, the error message can include the reason(s) of the error. For example, the reason(s) of the error can include one or more of the following: the net total is less than or equal to 0, the net total exceeds a purchase power, either the refund credit or the purchase cost is less than or equal to 0, or either there is no reserved instance refunded or there is no VM instance purchased in the exchange transaction. The user can then adjust the exchange transaction and resubmit the exchange transaction after adjustments.

FIG. 3, FIG. 4, FIG. 5, and FIG. 6 describe an example process of using the VM management application to perform a VM exchange transaction. In this example, the VM management application recommends to return one VM instance located in the west region, which may be paid for but not used. Additionally, the VM management application recommends to purchase VM instances located in the east region, where the purchase recommendation may be based on current usage or future need for VM instances in the east region.

FIG. 3 illustrates an example refund recommendation page 300, according to an implementation of the present disclosure. As illustrated, the top of the page shows a plurality of service accounts 328, including AWS, Azure, GCP, AliCloud, and Azure China, where the selected service account Azure can be underlined. The top of the page also shows the user ID 330 of the user who currently logs into the VM management application. The page includes information associated with the user account, including account 302, cost center 304, and end date 306. Account 302 shows the name of the LoB that the user account belongs to. Cost center 304 shows a number of the cost center which the net total of the VM exchange transaction can be billed to. End date 306 specifies the end date requested by the user to terminate the VM instance reservation(s) in a VM exchange transaction.

As illustrated in FIG. 3, the refund recommendations include a table that has a plurality of columns and a plurality of rows, each row corresponding to a VM instance reservation and each column corresponding to an attribute of a VM instance reservation. For example, FIG. 3 shows three VM instance reservations 320, 322, and 324. The attributes of a VM instance reservation include, for example, service type 308, region 310, recommended quantity to return 312, reservation start date 314, reservation end date 316, and credit 318. The service type 308 indicates the service type that the reserved VM instances of a VM instance reservation are used for. For example, the service types can be video, games, scientific computing, etc. The region 310 indicates the geographical region (e.g., east, west, etc.) that the reserved VM instances of a VM instance reservation are located. The recommended quantity to return 312 indicates the recommended quantity of VM instances to return in a VM instance reservation. The reservation start date 314 indicates the contract starting date of a VM instance reservation. The reservation end date 316 indicates the contract end date of a VM instance reservation. The credit 318 indicates the available refund for returning the recommended quantity of VM instances to the cloud service provider. The user can select one or more VM instance reservations by placing checkmark(s) 326 before the one or more VM instance reservations. After the user selects the reserved instances to refund, the VM management application can display a refund adjustment page.

FIG. 4 illustrates an example refund adjustment page 400, according to an implementation of the present disclosure. The refund adjustment page 400 shows a VM instance reservation 412 selected by the user. For each selected VM instance reservation, the refund adjustment page 400 can display attributes of the VM instance reservation, including return quantity 402, recommended quantity to return 404, credit 406, region 408, and service type 410. The refund adjustment page 400 provides controls, such as the plus control 414 and the minus control 416, for the user to adjust the return quantities. In some cases, the allowed range for adjustment is between 1 and the total quantity of reserved VM instances currently owned. The total credit 418 of the current refund can be displayed in the refund adjustment page 400. Once the refund quantities have been finalized, the user can navigate to the purchase recommendation page.

FIG. 5 illustrates an example purchase recommendation page 500, according to an implementation of the present disclosure. As illustrated in FIG. 5, the information associated with the user account is displayed, including account 502, cost center 504, term 506, and period 508. The term 506 indicates the length of contract requested by the user. In the period 508, the user can customize a period of historical usage of on-demand instances (e.g., usage of the on-demand instances in the last seven days, usage of the on-demand instances in the last 30 days, etc.) to be used for the calculations of purchase recommendations.

As illustrated in FIG. 5, the purchase recommendations include a table that has a plurality of columns and a plurality of rows, each row corresponding to a recommended purchase reservation and each column corresponding to an attribute of a recommended purchase reservation. For example, FIG. 5 shows three recommended purchase reservations 520, 522, and 524. The attributes of a recommended purchase reservation include, for example, service type 510, region 512, recommended quantity to purchase 514, and upfront cost 516. The service type 510 indicates the service type that the VM instances of a recommended purchase reservation are used for. The region 512 indicates the geographical region (e.g., east, west, etc.) that the VM instances of a recommended purchase reservation are located. The recommended quantity to purchase 514 indicates the recommended quantity of VM instances to purchase in a recommended purchase reservation. The upfront cost 516 indicates the purchase cost of the recommended purchase reservation. The user can select one or more recommended purchase reservations by placing checkmark(s) 526 before the one or more recommended purchase reservations. The current purchase cost 528 can be displayed in the purchase recommendation page 500. After selecting the VM instances to purchase, the user can navigate to the review page.

FIG. 6 illustrates an example review page 600, according to an implementation of the present disclosure. As illustrated, the review page can include the refund reservation(s) 602 and the purchase reservation(s) 604. Additionally, the review page can include the refund credit 606, the purchase cost 608, the net total 610, the weekly purchase power 612, and the daily purchase power 614. The net total 610 can be determined by subtracting the refund credit 606 from the purchase cost 608. The example review page 600 provides user with the chance to adjust the return quantity and/or the purchase quantity. After the user hits the “Exchange” button 616, the VM management application can send an exchange request to an API associated with Azure for execution of the VM exchange transaction.

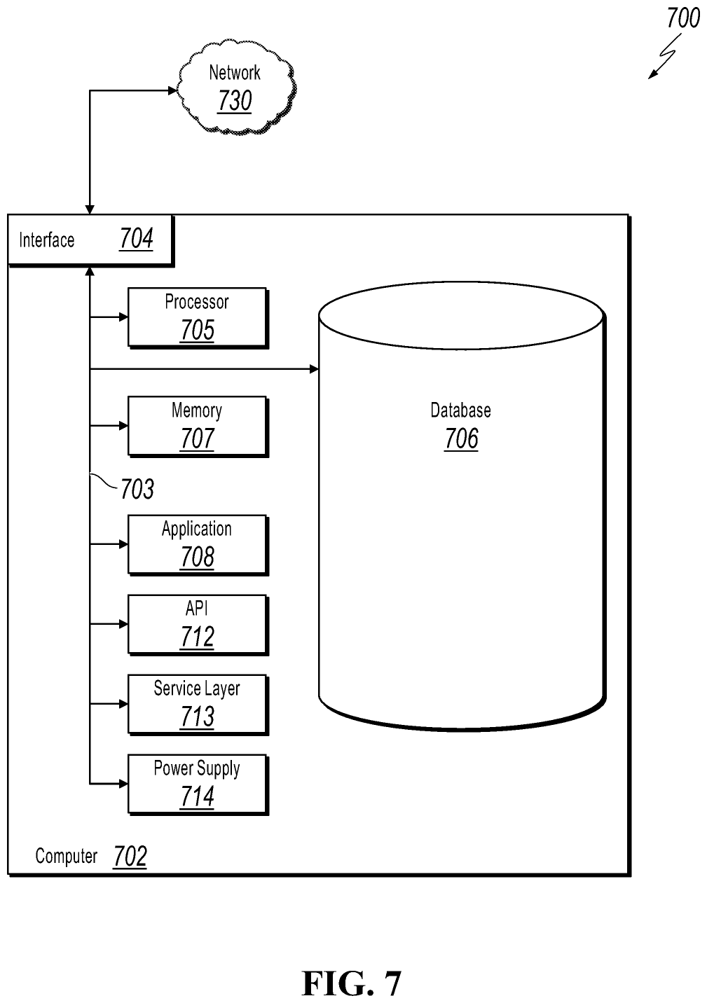

FIG. 7 is a block diagram illustrating an example of a computer-implemented System 700 used to provide computational functionalities associated with described algorithms, methods, functions, processes, flows, and procedures, according to an implementation of the present disclosure. In the illustrated implementation, System 700 includes a Computer 702 and a Network 730.

The illustrated Computer 702 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 702 can include an input device, such as a keypad, keyboard, or touch screen, or a combination of input devices that can accept user information, and an output device that conveys information associated with the operation of the Computer 702, including digital data, visual, audio, another type of information, or a combination of types of information, on a graphical-type user interface (UI) (or GUI) or other UI.

The Computer 702 can serve in a role in a distributed computing system as, for example, a client, network component, a server, or a database or another persistency, or a combination of roles for performing the subject matter described in the present disclosure. The illustrated Computer 702 is communicably coupled with a Network 730. In some implementations, one or more components of the Computer 702 can be configured to operate within an environment, or a combination of environments, including cloud-computing, local, or global.

At a high level, the Computer 702 is an electronic computing device operable to receive, transmit, process, store, or manage data and information associated with the described subject matter. According to some implementations, the Computer 702 can also include or be communicably coupled with a server, such as an application server, e-mail server, web server, caching server, or streaming data server, or a combination of servers.

The Computer 702 can receive requests over Network 730 (for example, from a client software application executing on another Computer 702) and respond to the received requests by processing the received requests using a software application or a combination of software applications. In addition, requests can also be sent to the Computer 702 from internal users (for example, from a command console or by another internal access method), external or third-parties, or other entities, individuals, systems, or computers.

Each of the components of the Computer 702 can communicate using a System Bus 703. In some implementations, any or all of the components of the Computer 702, including hardware, software, or a combination of hardware and software, can interface over the System Bus 703 using an application programming interface (API) 712, a Service Layer 713, or a combination of the API 712 and Service Layer 713. The API 712 can include specifications for routines, data structures, and object classes. The API 712 can be either computer-language independent or dependent and refer to a complete interface, a single function, or even a set of APIs. The Service Layer 713 provides software services to the Computer 702 or other components (whether illustrated or not) that are communicably coupled to the Computer 702. The functionality of the Computer 702 can be accessible for all service consumers using the Service Layer 713. Software services, such as those provided by the Service Layer 713, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 702, alternative implementations can illustrate the API 712 or the Service Layer 713 as stand-alone components in relation to other components of the Computer 702 or other components (whether illustrated or not) that are communicably coupled to the Computer 702. Moreover, any or all parts of the API 712 or the Service Layer 713 can be implemented as a child or a sub-module of another software module, enterprise application, or hardware module without departing from the scope of the present disclosure.

The Computer 702 includes an Interface 704. Although illustrated as a single Interface 704, two or more Interfaces 704 can be used according to particular needs, desires, or particular implementations of the Computer 702. The Interface 704 is used by the Computer 702 for communicating with another computing system (whether illustrated or not) that is communicatively linked to the Network 730 in a distributed environment. Generally, the Interface 704 is operable to communicate with the Network 730 and includes logic encoded in software, hardware, or a combination of software and hardware. More specifically, the Interface 704 can include software supporting one or more communication protocols associated with communications, such that the Network 730 or hardware of Interface 704 is operable to communicate physical signals within and outside of the illustrated Computer 702.

The Computer 702 includes a Processor 705. Although illustrated as a single Processor 705, two or more Processors 705 can be used according to particular needs, desires, or particular implementations of the Computer 702. Generally, the Processor 705 executes instructions and manipulates data to perform the operations of the Computer 702 and any algorithms, methods, functions, processes, flows, and procedures as described in the present disclosure.

The Computer 702 also includes a Database 706 that can hold data for the Computer 702, another component communicatively linked to the Network 730 (whether illustrated or not), or a combination of the Computer 702 and another component. For example, Database 706 can be an in-memory or conventional database storing data consistent with the present disclosure. In some implementations, Database 706 can be a combination of two or more different database types (for example, a hybrid in-memory and conventional database) according to particular needs, desires, or particular implementations of the Computer 702 and the described functionality. Although illustrated as a single Database 706, two or more databases of similar or differing types can be used according to particular needs, desires, or particular implementations of the Computer 702 and the described functionality. While Database 706 is illustrated as an integral component of the Computer 702, in alternative implementations, Database 706 can be external to the Computer 702. As illustrated, the Database 706 can hold one or more data types consistent with this disclosure.

The Computer 702 also includes a Memory 707 that can hold data for the Computer 702, another component or components communicatively linked to the Network 730 (whether illustrated or not), or a combination of the Computer 702 and another component. Memory 707 can store any data consistent with the present disclosure. In some implementations, Memory 707 can be a combination of two or more different types of memory (for example, a combination of semiconductor and magnetic storage) according to particular needs, desires, or particular implementations of the Computer 702 and the described functionality. Although illustrated as a single Memory 707, two or more Memories 707 or similar or differing types can be used according to particular needs, desires, or particular implementations of the Computer 702 and the described functionality. While Memory 707 is illustrated as an integral component of the Computer 702, in alternative implementations, Memory 707 can be external to the Computer 702.

The Application 708 is an algorithmic software engine providing functionality according to particular needs, desires, or particular implementations of the Computer 702, particularly with respect to functionality described in the present disclosure. For example, Application 708 can serve as one or more components, modules, or applications. Further, although illustrated as a single Application 708, the Application 708 can be implemented as multiple Applications 708 on the Computer 702. In addition, although illustrated as integral to the Computer 702, in alternative implementations, the Application 708 can be external to the Computer 702.

The Computer 702 can also include a Power Supply 714. The Power Supply 714 can include a rechargeable or non-rechargeable battery that can be configured to be either user- or non-user-replaceable. In some implementations, the Power Supply 714 can include power-conversion or management circuits (including recharging, standby, or another power management functionality). In some implementations, the Power Supply 714 can include a power plug to allow the Computer 702 to be plugged into a wall socket or another power source to, for example, power the Computer 702 or recharge a rechargeable battery.

There can be any number of Computers 702 associated with, or external to, a computer system containing Computer 702, each Computer 702 communicating over Network 730. Further, the term “client,” “user,” or other appropriate terminology can be used interchangeably, as appropriate, without departing from the scope of the present disclosure. Moreover, the present disclosure contemplates that many users can use one Computer 702, or that one user can use multiple computers 702.

Described implementations of the subject matter can include one or more features, alone or in combination.

For example, in a first implementation, a computer-implemented method, comprising: obtaining, from a cloud service provider, utilization data of reserved virtual machine (VM) instances; generating, based on the utilization data, a refund recommendation comprising a first quantity of VM instances and a refund credit associated with the first quantity of VM instances; generating a purchase recommendation comprising a second quantity of VM instances and a purchase cost associated with the second quantity of VM instances; and executing an exchange transaction to return the first quantity of VM instances and purchase the second quantity of VM instances, wherein a net total of the exchange transaction is determined based on the refund credit and the purchase cost.

The foregoing and other described implementations can each, optionally, include one or more of the following features:

A first feature, combinable with any of the following features, including before generating the refund recommendation: determining the first quantity of VM instances based on the utilization data and a total quantity of the reserved VM instances, wherein the utilization data indicates a utilization of the reserved VM instances over a predetermined period of time.

A second feature, combinable with any of the previous or following features, where the first quantity of VM instances is equal to a ratio multiplying by the total quantity of the reserved VM instances, and wherein the ratio is determined based on the utilization data.

A third feature, combinable with any of the previous or following features, including: determining an upfront cost and a used cost associated with the first quantity of VM instances; and determining the refund credit by subtracting the used cost from the upfront cost.

A fourth feature, combinable with any of the previous or following features, where determining the upfront cost and the used cost comprises: obtaining, from the cloud service provider, a preliminary cost associated with the first quantity of VM instances; determining a discounted cost based on the preliminary cost and a discount provided by the cloud service provider; and determining the upfront cost and the used cost based on the discounted cost.

A fifth feature, combinable with any of the previous or following features, where the first quantity of VM instances is associated with a user account, and wherein the user account is associated with a purchase power indicating an amount the user account is allowed to spend over a predetermined period of time.

A sixth feature, combinable with any of the previous or following features, including: after executing the exchange transaction, determining an updated purchase power based on subtracting the net total from the purchase power.

A seventh feature, combinable with any of the previous or following features, including: determining that the exchange transaction is valid, wherein determining that the exchange transaction is valid comprises at least one of: determining that the net total is greater than 0; determining that the net total is less than or equal to a purchase power; determining that each of the refund credit and the purchase cost is greater than 0; or determining that the first quantity of VM instances comprise at least one first reserved instance and that the second quantity of VM instances comprise at least one second reserved instance.

An eighth feature, combinable with any of the previous or following features, where determining that the net total is less than or equal to the purchase power comprises: determining that (i) the net total is less than or equal to a daily purchase power and (ii) the net total is less than or equal to a weekly purchase power.

A ninth feature, combinable with any of the previous or following features, where determining that (i) the net total is less than or equal to the daily purchase power and (ii) the net total is less than or equal to the weekly purchase power comprises: determining that the net total is less than or equal to the weekly purchase power; and in response to determining that the net total is less than or equal to the weekly purchase power, determining that the net total is less than or equal to the daily purchase power.

In a second implementation, a non-transitory, computer-readable medium storing one or more instructions executable by a computer system to perform operations comprising: obtaining, from a cloud service provider, utilization data of reserved virtual machine (VM) instances; generating, based on the utilization data, a refund recommendation comprising a first quantity of VM instances and a refund credit associated with the first quantity of VM instances; generating a purchase recommendation comprising a second quantity of VM instances and a purchase cost associated with the second quantity of VM instances; and executing an exchange transaction to return the first quantity of VM instances and purchase the second quantity of VM instances, wherein a net total of the exchange transaction is determined based on the refund credit and the purchase cost.

The foregoing and other described implementations can each, optionally, include one or more of the following features:

A first feature, combinable with any of the following features, including before generating the refund recommendation: determining the first quantity of VM instances based on the utilization data and a total quantity of the reserved VM instances, wherein the utilization data indicates a utilization of the reserved VM instances over a predetermined period of time.

A second feature, combinable with any of the previous or following features, where the first quantity of VM instances is equal to a ratio multiplying by the total quantity of the reserved VM instances, and wherein the ratio is determined based on the utilization data.

A third feature, combinable with any of the previous or following features, including: determining an upfront cost and a used cost associated with the first quantity of VM instances; and determining the refund credit by subtracting the used cost from the upfront cost.

A fourth feature, combinable with any of the previous or following features, where determining the upfront cost and the used cost comprises: obtaining, from the cloud service provider, a preliminary cost associated with the first quantity of VM instances; determining a discounted cost based on the preliminary cost and a discount provided by the cloud service provider; and determining the upfront cost and the used cost based on the discounted cost.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: obtaining, from a cloud service provider, utilization data of reserved virtual machine (VM) instances; generating, based on the utilization data, a refund recommendation comprising a first quantity of VM instances and a refund credit associated with the first quantity of VM instances; generating a purchase recommendation comprising a second quantity of VM instances and a purchase cost associated with the second quantity of VM instances; and executing an exchange transaction to return the first quantity of VM instances and purchase the second quantity of VM instances, wherein a net total of the exchange transaction is determined based on the refund credit and the purchase cost.

The foregoing and other described implementations can each, optionally, include one or more of the following features:

A first feature, combinable with any of the following features, including before generating the refund recommendation: determining the first quantity of VM instances based on the utilization data and a total quantity of the reserved VM instances, wherein the utilization data indicates a utilization of the reserved VM instances over a predetermined period of time.

A second feature, combinable with any of the previous or following features, where the first quantity of VM instances is equal to a ratio multiplying by the total quantity of the reserved VM instances, and wherein the ratio is determined based on the utilization data.

A third feature, combinable with any of the previous or following features, including: determining an upfront cost and a used cost associated with the first quantity of VM instances; and determining the refund credit by subtracting the used cost from the upfront cost.

A fourth feature, combinable with any of the previous or following features, where determining the upfront cost and the used cost comprises: obtaining, from the cloud service provider, a preliminary cost associated with the first quantity of VM instances; determining a discounted cost based on the preliminary cost and a discount provided by the cloud service provider; and determining the upfront cost and the used cost based on the discounted cost.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
obtaining, from a cloud service provider, utilization data of reserved virtual machine (VM) instances;
generating, based on the utilization data, a refund recommendation comprising a first quantity of VM instances and a refund credit associated with the first quantity of VM instances;
generating a purchase recommendation comprising a second quantity of VM instances and a purchase cost associated with the second quantity of VM instances; and
executing an exchange transaction to return the first quantity of VM instances and purchase the second quantity of VM instances, wherein a net total of the exchange transaction is determined based on the refund credit and the purchase cost.

2. The computer-implemented method of claim 1, comprising, before generating the refund recommendation:
determining the first quantity of VM instances based on the utilization data and a total quantity of the reserved VM instances, wherein the utilization data indicates a utilization of the reserved VM instances over a predetermined period of time.

3. The computer-implemented method of claim 2, wherein the first quantity of VM instances is equal to a ratio multiplying by the total quantity of the reserved VM instances, and wherein the ratio is determined based on the utilization data.

4. The computer-implemented method of claim 1, comprising:
determining an upfront cost and a used cost associated with the first quantity of VM instances; and
determining the refund credit by subtracting the used cost from the upfront cost.

5. The computer-implemented method of claim 4, wherein determining the upfront cost and the used cost comprises:
obtaining, from the cloud service provider, a preliminary cost associated with the first quantity of VM instances;
determining a discounted cost based on the preliminary cost and a discount provided by the cloud service provider; and
determining the upfront cost and the used cost based on the discounted cost.

6. The computer-implemented method of claim 1, wherein the first quantity of VM instances is associated with a user account, and wherein the user account is associated with a purchase power indicating an amount the user account is allowed to spend over a predetermined period of time.

7. The computer-implemented method of claim 6, comprising:
after executing the exchange transaction, determining an updated purchase power based on subtracting the net total from the purchase power.

8. The computer-implemented method of claim 1, comprising:
determining that the exchange transaction is valid, wherein determining that the exchange transaction is valid comprises at least one of:
determining that the net total is greater than 0;
determining that the net total is less than or equal to a purchase power;
determining that each of the refund credit and the purchase cost is greater than 0; or
determining that the first quantity of VM instances comprise at least one first reserved instance and that the second quantity of VM instances comprise at least one second reserved instance.

9. The computer-implemented method of claim 8, wherein determining that the net total is less than or equal to the purchase power comprises:
determining that (i) the net total is less than or equal to a daily purchase power and (ii) the net total is less than or equal to a weekly purchase power.

10. The computer-implemented method of claim 9, wherein determining that (i) the net total is less than or equal to the daily purchase power and (ii) the net total is less than or equal to the weekly purchase power comprises:
determining that the net total is less than or equal to the weekly purchase power; and
in response to determining that the net total is less than or equal to the weekly purchase power, determining that the net total is less than or equal to the daily purchase power.

11. A non-transitory, computer-readable medium storing one or more instructions executable by a computer system to perform operations comprising:
obtaining, from a cloud service provider, utilization data of reserved virtual machine (VM) instances;
generating, based on the utilization data, a refund recommendation comprising a first quantity of VM instances and a refund credit associated with the first quantity of VM instances;
generating a purchase recommendation comprising a second quantity of VM instances and a purchase cost associated with the second quantity of VM instances; and
executing an exchange transaction to return the first quantity of VM instances and purchase the second quantity of VM instances, wherein a net total of the exchange transaction is determined based on the refund credit and the purchase cost.

12. The non-transitory, computer-readable medium of claim 11, the operations comprising, before generating the refund recommendation:
determining the first quantity of VM instances based on the utilization data and a total quantity of the reserved VM instances, wherein the utilization data indicates a utilization of the reserved VM instances over a predetermined period of time.

13. The non-transitory, computer-readable medium of claim 12, wherein the first quantity of VM instances is equal to a ratio multiplying by the total quantity of the reserved VM instances, and wherein the ratio is determined based on the utilization data.

14. The non-transitory, computer-readable medium of claim 11, the operations comprising:
determining an upfront cost and a used cost associated with the first quantity of VM instances; and
determining the refund credit by subtracting the used cost from the upfront cost.

15. The non-transitory, computer-readable medium of claim 14, wherein determining the upfront cost and the used cost comprises:
obtaining, from the cloud service provider, a preliminary cost associated with the first quantity of VM instances;
determining a discounted cost based on the preliminary cost and a discount provided by the cloud service provider; and
determining the upfront cost and the used cost based on the discounted cost.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, from a cloud service provider, utilization data of reserved virtual machine (VM) instances;
generating, based on the utilization data, a refund recommendation comprising a first quantity of VM instances and a refund credit associated with the first quantity of VM instances;
generating a purchase recommendation comprising a second quantity of VM instances and a purchase cost associated with the second quantity of VM instances; and
executing an exchange transaction to return the first quantity of VM instances and purchase the second quantity of VM instances, wherein a net total of the exchange transaction is determined based on the refund credit and the purchase cost.

17. The computer-implemented system of claim 16, the operations comprising, before generating the refund recommendation:
determining the first quantity of VM instances based on the utilization data and a total quantity of the reserved VM instances, wherein the utilization data indicates a utilization of the reserved VM instances over a predetermined period of time.

18. The computer-implemented system of claim 17, wherein the first quantity of VM instances is equal to a ratio multiplying by the total quantity of the reserved VM instances, and wherein the ratio is determined based on the utilization data.

19. The computer-implemented system of claim 16, the operations comprising:
determining an upfront cost and a used cost associated with the first quantity of VM instances; and
determining the refund credit by subtracting the used cost from the upfront cost.

20. The computer-implemented system of claim 19, wherein determining the upfront cost and the used cost comprises:
obtaining, from the cloud service provider, a preliminary cost associated with the first quantity of VM instances;
determining a discounted cost based on the preliminary cost and a discount provided by the cloud service provider; and
determining the upfront cost and the used cost based on the discounted cost.
